(19) United States
(12) Patent Application Publication
(10) Pub. No.: US 2003/0206225 A1
(43) Pub. Date: Nov. 6, 2003

(54) Drying installation within a sheet-fed printing press

(76) Inventor: Andreas Ihme, Goldbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/332,514

(22) PCT Filed: Jun. 12, 2001
(86) PCT No.: PCT/EP01/06612

(30) Foreign Application Priority Data
Jul. 12, 2000 (DE) 100338399

(51) Int. Cl. G03G 13/04

(52) U.S. Cl. 347/130; 347/154

(57) ABSTRACT

The invention pertains to a drying apparatus within a sheet-fed printing machine, in particular, a sheet-fed offset printing machine, with a device for acting upon the moving sheets with air and/or heat. The present invention is based on the objective of expanding a drying apparatus of this type in such a way that the drying effect is improved. According to the invention, this is achieved due to the fact that the apparatus contains an electrode (E) and a corresponding counter-electrode, wherein the electrode is connected to a high-voltage source (HV) and a high voltage is applied to the electrode by the high-voltage source in dependence on the operation of the sheet-fed printing machine and/or the length of the sheets (B).

The invention pertains to a drying apparatus within a sheet-fed printing machine according to the preamble of claim 1.

### STATE OF THE ART

In sheet-fed offset printing machines, the sheets to be printed are transported through the individual printing stations and, after the last printing station, through one or more varnishing or other converting devices by means of cylinders and drums. The transport of the sheets from the last drum to the delivery stack is realized with the aid of chain systems.

Drying apparatuses are provided at various locations within the printing machine in order to prevent the freshly printed sheets from becoming smeared during their transport between the individual printing stations and between the last printing station and the delivery station or the varnishing device. The drying apparatuses are provided for drying/absorbing the ink/varnish as rapidly as possible such that any contact between the printed side of the sheet and sheet guiding plates or other stationary parts, does not lead to damage on the printed side and consequently waste sheets.

Printing inks or varnishes that are based on solvents release solvent vapors during the drying process. Such a drying process can be accelerated with the aid of IR radiators because the evaporation of the solvent is expedited by applied heat. This drying process can be additionally accelerated if the printed sheet is subsequently impacted with warm air because the solvent vapors released by the printed sheet due to the applied heat can be transported away in this fashion. In drying processes of this type, the air that is saturated with solvent and water vapor can also be removed by suction. However, this requires a special suction apparatus.

DE 195 25 453 A1 discloses a drying method for rapidly moving webs to be printed, wherein an electrode that is connected to a high-voltage source is provided adjacent to drying apparatuses. The current of electric charge carriers that is moved in the direction of the material to be printed (rapidly moving web) by the electrode causes a destruction of the laminar boundary layer entrained by the moving web. This laminar boundary layer that is entrained by the material to be printed (web) inhibits the mass transfer of solvent and water vapor from the material being printed, i.e., the mass transfer coefficient is lowered. However, this drying principle which utilizes a high-voltage electrode can only be used on rapidly moving webs and is not suitable for sheet-fed printing machines in the disclosed form.

### OBJECTIVE OF THE INVENTION

The present invention is based on the objective of expanding a drying apparatus according to the preamble of claim 1 in such a way that the abovementioned disadvantages are eliminated and an improved drying effect is achieved.

This objective is attained with the characteristics disclosed in the characterizing portion of claim 1.

### Examples

The invention proposes that the drying apparatus contains an electrode (E) and a corresponding counter-electrode, wherein the electrode is connected to a high-voltage source (HV) and a high voltage is applied to the electrode by the high-voltage source in dependence on the operation of the sheet-fed printing machine and/or the length of the sheets (B). This drying apparatus preferably also contains a suction device that makes it possible to remove by suction the vapors released from the material being printed and the ink due to the applied heat and air.

According to one embodiment of the invention, the drying apparatus preferably contains a device that is realized in the form of an IR radiator such that the material being printed and the ink and/or varnish layer can be subjected to exactly the wavelength that stimulates the solvent.

According to this embodiment of the invention, IR radiators subject the moving sheets to radiation with a wavelength with which only the solvent is heated. Due to the electrode that is positioned a short distance from the sheet surface and arranged downstream of the IR radiator viewed in the transport direction of the sheets, the mass transfer coefficient is increased by destroying laminar air layers above the sheet surface. This leads to an improvement in the mass conveyance (evaporation) of solvents. A pre-heated air current that simultaneously acts upon the sheets additionally simplifies the evaporation of solvents from the material being printed, and the air that is enriched with the solvent/water is simultaneously transported away. A corresponding device makes it possible to remove by suction the air that is enriched with solvent/water from the region of the drying apparatus and ultimately the printing machine.

The drying apparatus according to the invention which is also provided with an electrode and a corresponding counter-electrode can be used at various locations within the sheet-fed offset printing machine. The invention proposes that a high voltage be applied to the electrode in dependence on the printing speed and/or the length of the sheets being printed (format). It also needs to be ensured that the distance of the electrode from the surface of the sheet always assumes the required value. In this context, it also needs to be ensured that sheet holding devices, e.g., the gripping fingers of the cylinders that guide the sheets or the gripper systems of the delivery station, do not collide with the electrode or the counter-electrode. This problem can be solved by movably suspending the electrode or the carrier of the electrode and the counter-electrode assigned to the electrode such that they carry out yielding movements while the grippers or the sheet holding devices pass. Such a movable suspension of the electrode or the entire drying apparatus which is controlled in dependence on the sheet movement is particularly advantageous if the drying apparatus according to the invention should be assigned to the obverse of the sheet in the delivery station of the printing machine (sheet appearance). The gripper systems that hold the sheets may control the concordantly required yielding movements of the electrode by means of sensors arranged at the intended locations. The yielding movement of the electrode and/or the counter-electrode relative to the gripper systems is required because the electrodes impede the travel of the gripper systems.

Due to the movable suspension of the dryer and the electrode or the assigned counter-electrode relative to the sheet appearance in the delivery station, one or more drying apparatuses according to the invention can be provided in the entrance of the delivery station. This intensifies the drying effect in the region of the delivery station such that extensions within the delivery station which would result in a high constructive expenditure appear unnecessary.

The electrode according to the invention for promoting the drying effect is provided with at least one device that preferably subjects the sheets to warm air. The air current produced by this device is preferably realized in such a way that the sheet and, in particular, the sheet end cannot contact the electrode and parts assigned to the electrode.

The electrode according to the invention or the drying apparatus, respectively, may be arranged at various locations within a sheet-fed offset printing machine. For example, it is possible to arrange the electrode and the drying apparatus in the sheet guide upstream of the first offset printing station. This type of installation is particularly preferred in instances in which a priming station in the form of a flexographic printing station is arranged upstream of the printing stations.

The drying apparatus according to the invention can also be arranged within the sheet guide between the printing stations and assigned to the obverse of the sheet. In this case, the drying apparatus is directly installed into the sheet guiding plates opposite the counter-pressure cylinder. The electrodes can be installed by interrupting the plate-type sheet guide and installing a non-conductive material, for example, a plastic or ceramic material, into which the electrode is embedded. In this case, the counter-pressure cylinder serves as the counter-electrode and needs to be electrically connected accordingly (grounded).

The drying apparatus according to the invention may also be arranged in the sheet guide between the printing stations and assigned to the reverse. In the turning and reverse printing mode, two channels can be arranged in the counter-pressure cylinder such that they are offset relative to one another by 180E, wherein the electrode that is surrounded by a non-conductive material is embedded into said channels. In this case, the counter-electrode is embedded in a non-conductive material and installed in the sheet guide. The distance between the electrode and the sheet can be precisely adjusted depending on the respective requirements.

The drying apparatus can also be installed in the sheet guide between varnishing stations and assigned to the obverse. In this case, the installation is realized analogous to the installation between the printing stations.

It is also possible to arrange the drying apparatus according to the invention in a delivery drum or a sheet-guiding drum in the form of a stationary apparatus. The sheet being transported by the delivery or sheet guiding drum is subjected to the ionic radiation of the stationary electrode, past which the sheet is transported.

As in the case of an installation between the printing stations, in which the sheets are dried on the reverse, the drying apparatus according to the invention may also be arranged accordingly between two or more varnishing stations.

The drying apparatus may also be installed between the last printing station and the delivery station or within the delivery station at a location upstream of the delivery stack. The sheets can be dried on the obverse and on the reverse by correspondingly suspending the drying apparatus according to the invention statically or such that it can be moved in accordance with the sheet transport.

One or more drying apparatuses realized in accordance with the invention can be assigned to the obverse of the sheet in an extension module, in which the sheets are transported by a cylinder provided with grippers. These drying apparatuses are preferably realized such that their height referred to the material being printed (spacing) is adjustable. One or more drying apparatuses realized in accordance with the invention may also be arranged in the take-off drum or the ensuing transport path of the chain system. As mentioned above, a drying apparatus (electrode) that acts upon the obverse of the sheet needs to be suspended such that it can be moved in a controlled fashion in accordance with the sheet transport due to the risk of collisions with the gripper systems.

The counter-electrode assigned to the electrode may consist of the printing cylinder or the counter-pressure cylinder (their metallic surface), a sheet guiding plate or a metallic surface arranged on a sheet-guiding cylinder. It would also be conceivable to assign the drying apparatus to a turning drum. In this case, the counter-electrode assigned to the stationary electrode is preferably formed by the surface of the drum.

Embodiments of the invention are described below with reference to the figures. The figures show:

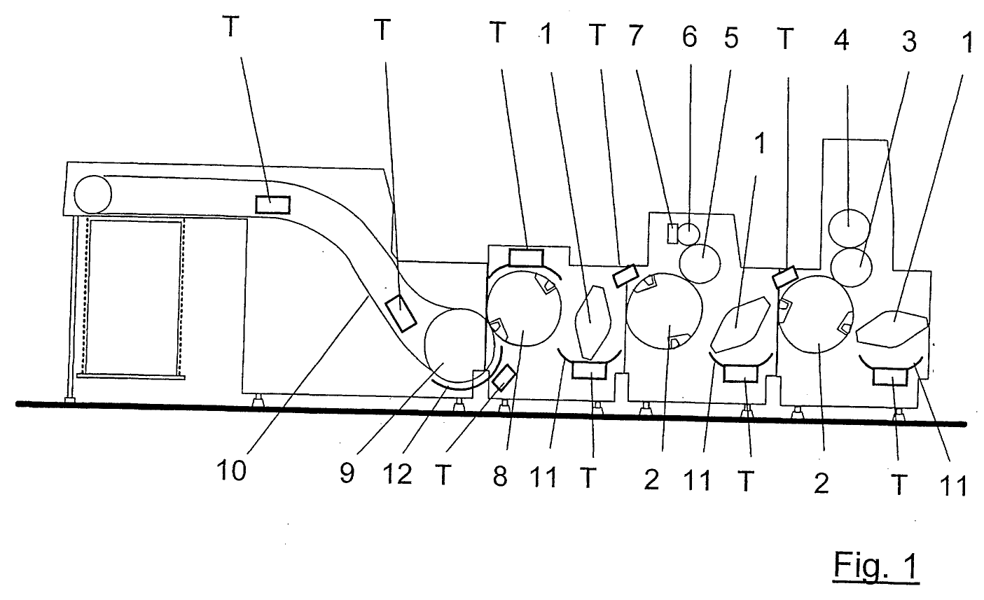

FIG. 1, a sheet-fed offset printing machine with a last printing station, an extension module, a varnishing station and a delivery station;

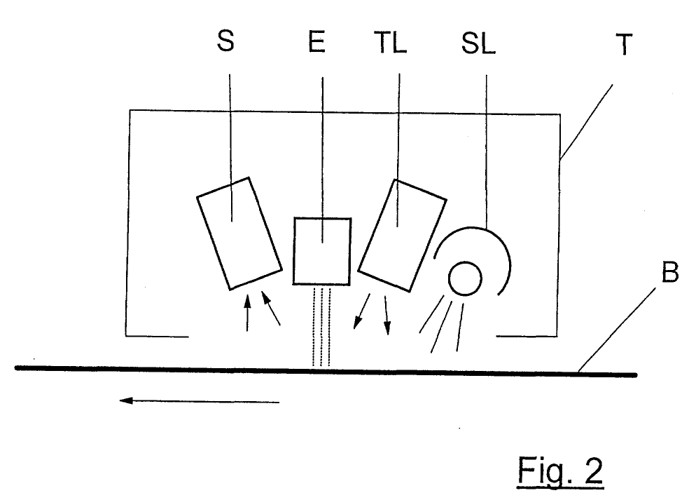

FIG. 2, the components of a drying apparatus according to the invention as arranged at various locations of the printing machine shown in FIG. 1, and

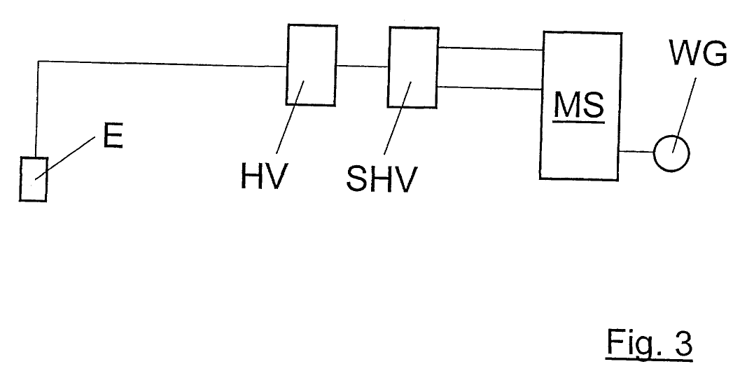

FIG. 3, the control of a drying apparatus according to the invention.

FIG. 1 shows the last printing station of a sheet-fed offset printing machine with a counter-pressure cylinder 2, a rubber blanket cylinder 3 and a plate cylinder 4. A transfer drum 1 for transporting the sheets from the preceding printing station is arranged upstream of the counter-pressure cylinder 2. The sheets transported by the transfer drum 1 are supported on the reverse by a sheet guide 11. A varnishing station with a counter-pressure cylinder 2, a form cylinder 5, an application roller 6 and a chamber doctor blade 7 that cooperates with the screened application roller 6 are arranged downstream of the counter-pressure cylinder 2 of the last printing station. From the counter-pressure cylinder 2 of the last printing station, the sheets are fed to the counter-pressure cylinder of the varnishing station by means of a transfer drum 1 with an assigned sheet guide 11. The sheets situated on the counter-pressure cylinder 2 in the varnishing station are fed to the take-off drum 9 of a delivery station by means of an additional transfer drum 1 and a sheet guiding drum 8 of an extension module. The sheets are fed from the take-off drum 9 to the delivery stack by means of gripper systems 10.

Sheet guides 11 that support the sheets on the reverse are assigned to the transfer drums 1. In addition, a sheet guide 12 is assigned to the take-off drum 9. The sheet guides 11, 12, may consist of sheet guiding plates that can be subjected to suction air and/or blasting air, sheet guiding rods or the like.

FIG. 2 shows the components of the preferred embodiment of the drying apparatus according to the invention. The sheet B is transported in the direction of the arrow. The drying apparatus T consists of a radiator ST [sic; SL] that this preferably realized in the form of an IR radiator, a blasting device TL that is arranged downstream of said radiator viewed in the sheet transport direction and acts upon the sheet B with diffuse warm air, an electrode E that is only illustrated schematically in FIG. 2 and a suction device S that is arranged downstream of the aforementioned devices viewed in the sheet transport direction.

According to FIG. 3, the electrode E is connected to a high-voltage source HV. This high voltage source is connected to a control SHV such that the times at which the voltage is applied to the electrode E, as well as the intensity of this voltage, can be precisely adjusted by the control SHV. A signal connection that is indicated by lines in this figure is provided between the control SHV for the electrode E and the machine control SM [sic; MS]. The machine control SM contains an angle transmitter WG that is mounted, in particular, on a single-speed shaft. The times at which the voltage is applied to the electrode E at a given point of installation can be determined by the machine control SM and the control of the high-voltage source SHV based on the signals of the angle transmitter. The signals of the angle transmitter WG make it possible, in particular, to determine at which time a gripper system in the transport path 10 of the delivery station passes the electrode E such that an actuator assigned to the electrode E is able to raise the electrode E. In addition, the signals of the angle transmitter WG make it possible to control the high-voltage source HV in such a way that the sheet B is subjected to the required ionic current that positively influences the drying properties in dependence on the printing speed and the length of the sheet. The distance between the electrode E and the sheet or the counter-electrode that is not illustrated in FIG. 3 can be adjusted by the control SHV in accordance with predetermined values.

FIG. 1 shows preferred points of installation for the drying apparatus that is schematically illustrated in FIG. 2. According to FIG. 1, one or more drying apparatuses T may be assigned to the sheet guide 11 of the last printing station, the varnishing station and the extension module. It is also possible to assign a drying apparatus T arranged downstream of the rubber blanket cylinder 3 to the surface of the counter-pressure cylinder 2 of the last printing station. One or more drying apparatuses T may also be assigned to the surface of the sheet-guiding cylinder 8 in the varnishing station. Analogous to the counter-pressure cylinder 2 of the last printing station, one or more drying apparatuses arranged downstream of the form cylinder 5 may also be assigned to the counter-pressure cylinder 2 of the varnishing station. The drying apparatuses T assigned to the counter-pressure cylinders 2 and the sheet guiding cylinders 8 are preferably suspended such that their distance from the cylinder surface is adjustable.

One or more drying apparatuses T according to the invention which act upon the reverse of the sheet may be assigned to the sheet guide 12 in the take-off drum 9 analogous to the drying apparatuses T arranged in the sheet guides 11. One or more drying apparatuses T may also be arranged in the entrance of the delivery system 10, wherein these drying apparatuses act upon the obverse of the sheet and are suspended in a controlled fashion so as to allow the gripper systems that hold the sheets to pass. In a sheet-fed offset printing machine for obverse and reverse printing, the transfer drums 1 may also consist of turning drums.

List of Reference Symbols

1 Transfer drum

2 Counter-pressure cylinder

3 Rubber blanket cylinder

4 Plate cylinder

5 Form cylinder

6 Application roller

7 Chamber doctor blade

8 Cylinder

9 Take-off drum

10 Delivery system

11 Sheet guide (transfer drum 1)

12 Sheet guide (take-off drum 9)

T Drying apparatus

S Suction device

E Electrode

TL Blasting air/warm air

SL Radiator

B Sheet

HV High-voltage source

SHV High-voltage source control

MS Printing machine control

WG Angle transmitter

1. Drying apparatus within a sheet-fed printing machine, in particular, a sheet-fed offset printing machine, with a device for acting upon the moving sheets with air and/or heat, characterized by the fact that the apparatus contains an electrode (E) and a corresponding counter-electrode, wherein the electrode is connected to a high-voltage source (HV) and a high voltage is applied to the electrode by the high-voltage source in dependence on the operation of the sheet-fed printing machine and/or the length of the sheets (B).

2. Drying apparatus according to claim 1, characterized by the fact that the drying apparatus (T) contains a blasting nozzle (TL) for acting upon the sheets with warm air.

3. Drying apparatus according to claim 1 or 2, characterized by the fact that the drying apparatus (T) contains a radiator (SL) for acting upon the sheets with IR radiation.

4. Drying apparatus according to one of the preceding claims, characterized by the fact that the drying apparatus (T) contains a suction device (S).

5. Drying apparatus according to one of the preceding claims, characterized by the fact that the electrode (E) can be controlled by means of a control (SHV) arranged upstream of the high-voltage source (HV) based on the signals of an angle transmitter (WG) of the machine control (SM).

6. Drying apparatus according to one of the preceding claims, characterized by the fact that the drying apparatus (T) in the sheet path is assigned to the obverse of the sheets (B).

7. Drying apparatus according to one of the preceding claims, characterized by the fact that the drying apparatus (T) in the sheet path is assigned to the reverse of the sheets (B).

8. Drying apparatus according to one of the preceding claims, characterized by the fact that the electrode (E) and/or the counter-electrode is/are suspended such that it/they can be moved essentially perpendicular to the transport direction of the sheets (B).

9. Drying apparatus according to claim 8, characterized by the fact that the electrode (E) and/or the counter-electrode can be moved in a controlled fashion by means of an angle transmitter (WG).

10. Drying apparatus according to claim 8 or 9, characterized by the fact that the electrode (E) and/or the counter-electrode in the delivery system (10) can be moved in a controlled fashion relative to the moving path of the gripping devices that hold the sheets.
